(19) United States
(12) Patent Application Publication
(10) Pub. No.: US 2010/0294264 A1
(43) Pub. Date: Nov. 25, 2010

(54) ABSORBER FOR A THERMAL SOLAR COLLECTOR AND METHOD FOR THE PRODUCTION OF SUCH AN ABSORBER

(76) Inventor: Andreas Link, Berlin (DE)

Correspondence Address: HESPOS & PORCO LLP, 110 West 40th Street, Suite 2501, NEW YORK, NY, 10018, US

(21) Appl. No.: 12/676,383

(22) PCT Filed: Sep. 4, 2008
(86) PCT No.: PCT/EP2008/007409

§ 371 Date: Jul. 1, 2010

(30) Foreign Application Priority Data
Sep. 4, 2007 (DE) 10 2007 042 387.1

(51) Int. Cl. F24J 2/48; B23K 26/00

(52) U.S. Cl. 126/677; 219/121.64

(57) ABSTRACT

An absorber (1) for a thermal solar collector, comprising an absorber sheet (3) and at least one thermal fluid tube (5) that is connected in a thermally conducting fashion to the absorber sheet (3) and is connected to the absorber sheet (3) by means of a welded joint, is characterized in that the welded joint is formed from a number of linearly extended weld seam sections arranged sequentially along the thermal fluid tube (5) and respectively separated from one another by a section without weld seam, the direction of the linear extent of the weld seam sections corresponding to the axial direction of the extent of the thermal fluid tube.

### BACKGROUND OF THE INVENTION

1. Field of the Invention

The present invention relates to an absorber for a thermal solar collector having an absorber sheet and at least one thermal fluid tube connected in a thermally conducting fashion to the sheet. The present invention also relates to a method for producing an absorber for a thermal solar collector.

2. Description of the Related Art

A thermal solar collector absorbs the radiation of the sun and converts this into heat. The collected heat is transferred to a thermal fluid as transport means that transports the heat to its point of destination.

The core of a thermal solar collector is the absorber. This comprises a specifically coated sheet, called an absorber sheet below, and at least one tube connected in a thermally conducting fashion to the sheet. When the sheet is heated because of insolation, the heat is passed on to the thermal fluid flowing through the tubes. A circulation of the thermal fluid can then be used, for example, to transport the heat into the heating circuit of a building, where it is finally released.

Various designs of thermal solar collectors and absorber sheets have been developed for different applications. The best known are flat collectors, vacuum collectors and solar absorbers.

In most absorbers, the thermal fluid tube is soldered or welded onto the absorber sheet. Plasma welding methods or laser welding methods, for example, are applied in order to weld the tube to the absorber sheet. EP 0 794 032 B1 describes a laser welding method in which a pulsed laser is used for welding. However, in alternative connection techniques the tube can also be clamped in a profile of the absorber sheet which is specifically shaped therefor, or be pressed into the absorber sheet. It is likewise possible to fold the absorber sheet around the tube.

The prior art is the use of a pulsed, lamp-pumped YAG laser which produces individual connecting points between tube and sheet (described in EP 0 794 032 B1). However, diode-pumped pulsed welding sources are also conceivable for these applications. The connecting points are generally produced without feeding additives. A relatively high and abrupt input of energy into one of the materials to be connected, caused by the sudden discharge of the pulsed laser source, leads by material accumulation to a connecting point between the two materials.

An excessively high input of energy into the material leads to a large weld zone which leads to warping of the sheet and thus to problems in the manufacturing process (wrinkling of the sheet/foil, formation of holes in the sheet/foil, lack of connection between the materials, stresses in the structure).

Consequently, a low energy input is of interest in the case of this method. This is opposed by various parameters such as, for example, the welding speed, the pulse frequency, the focusing or the power of the laser, and the parameters set narrow limits in the output of such a manufacturing plant.

As a rule, approximately 1000 connecting points are made on both sides of a 1 meter tube in this method.

Thin threads which branch off from the sheet and are lengthened toward the tube are characteristic of the connection. It resembles stitching. When a load is applied, a so-called zipper effect can be observed. The entire connection of the structure is increasingly weakened with each disintegrating connecting point. A detachment of the sheet from the tube, and thus an increasing loss of efficiency result.

The tubes guiding the thermal fluid can be arranged on the front side of the absorber sheet, facing the sun, or on its rear side, averted from the sun.

On the front side, absorber sheets have a coating which converts the insolation (direct and diffuse) as completely as possible into heat and is intended to pass on the latter with no loss.

Various methods are available for coating: applications of solvent-based varnish, wet chemical heavy metal deposition methods, magnetron sputtering and electron beam evaporation in reactive variants.

The two methods of magnetron sputtering and electron beam evaporation in reactive variants have become established as coating techniques with reference to efficiency and environmental compatibility. The layers which are produced with these technologies are distinguished by high hardness and good chemical resistance. They are denoted as selective coating and are applied, in particular, in industrial absorber manufacturing. It is built up in a plurality of layers. The coating itself in this case has a thickness of only 2 μm. On the rear side, selectively coated aluminum sheet is additionally given a transparent protective layer against corrosion.

The coating of a ready made welded absorber (sheet/foil welded to tube/tube structure) is impossible in the case of the last named methods. In the coating plants only sheet strips from coil can be processed, thereafter being made available to the absorber manufacturing for further processing.

Welding methods constitute a technical challenge in the use of sheets coated in such a way.

The different material thicknesses lead to different melting points. Alternatives are being sought in the sector in order to economize on material costs. One of these is aluminum as backing material for the selective coating. However, the use of various materials exacerbates these problems in the manufacturing process. These problems are made plain through looking at the different melting temperatures of copper (material of the tube), namely 1083° C., and of aluminum, namely only 660° C. (material of the sheet).

The connection is to be frictional, and optimally, material, in order to be able to absorb all forces which occur and act on the structure. In addition, the coating of the sheet is not to be destroyed, if possible.

A round tube with a sheet (tangent) lying thereon has only a single point of contact (contact line). To the left and right on the point of contact of the tangent which results in the cross section of the structure a dead point (angle) is respectively formed.

In order to produce an optimum connection by means of a weld seam, it is required to make the welded joint as close as possible to the upper dead point of the tube outside diameter. This is particularly difficult in tube bends. The material structure and the geometry of the tube cross section change in this section because of the manufacturing process of the bending.

The connection of the different materials (substances, material thickness) effects a different expansion behavior in length, width and cross section. The different coefficients of expansion (α₂₀ in 10⁻⁶/K) for aluminum (23.8) and for copper (16.8), and the resulting behavior of the two materials under thermal influence is evidence of this. Connecting points to the sheet which are made laterally at the tube outside diameter therefore tend towards a corresponding change in their original position under thermal action.

Change of thermal load exposes the welded joints permanently to various forces (tension, pressure, torsion) and loadings (inter alia, tension, shearing). Purely by simply considering tensile strength (10⁻⁷ in N/m²) and the differences when these different materials such as copper (40) and aluminum (25) are used, it is seen that it is precisely possible to avoid weakening an aluminum sheet used in the manufacturing process.

These loadings are intensified by a tube structure (tube coil, meander) fitted on the sheet. A meander (tube coil) generally used characteristically behaves like a tension and compression spring under thermal interaction.

A particular problem is the production of a permanent connection in tube bends. The acting forces and loadings have a particularly strong effect here.

Particularly in the case of connections produced between the absorber sheet and the thermal fluid tubes, the aim is to improve the efficiency of the thermal solar collector and to improve the quality of the connection (inter alia, homogeneity of the spot welds and of the microstructure). In the case of standard welding methods, however, either the coating of the sheet is destroyed in the region of the weld seam, or there is a failure to provide the connection with adequate strength which permanently withstands the loadings of tension, torsion and shearing which occur. This is particularly the case with connections of selectively coated aluminum sheets and copper tubes (bimetallic effect). Moreover, the efficiency of the welding methods previously used to connect the absorber sheet to the thermal fluid tubes is very low.

With regard to the prior art, it is therefore an object of the present invention to make available an improved absorber for thermal solar collectors.

A further object of the present invention is to make available an improved method for producing an absorber for a thermal solar collector, without destroying the coated surface.

### SUMMARY OF THE INVENTION

An inventive absorber for a thermal solar collector comprises an absorber sheet and at least one thermal fluid tube that is connected in a thermally conducting fashion to the absorber sheet and is connected to the absorber sheet by means of a welded joint. The welded joint is formed from a number of linearly extended weld seam sections arranged sequentially along the thermal fluid tube and respectively separated from one another by a section without weld seam, the direction of the linear extent of the weld seam sections corresponding to the axial direction of the extent of the thermal fluid tube.

Owing to the fact that the welded joint, which can, in particular, also be present in bent regions of the tube, is interrupted in the inventive absorber, there is an increase in the thermal contact area between sheet and tube by comparison with connections which only have spot welds produced by means of pulsed lasers, and this improves the transfer of heat. Moreover, the quality of the connection can be improved, since the welded joint of the inventive absorber can be produced by means of a continuously operating laser, the path to the weld seam to be formed being temporarily cleared and interrupted. There is thus no need for any actual interruptions of the welding process such as, for example, when welding with a pulsed laser beam. Welded joints of poorer quality arise upon applying and removing the welding set, that is to say upon switching the laser beam on and off with a pulsed laser, than is the case with a continuously operating laser.

A good collector performance that remains constant over decades can be ensured on the basis of the enlarged thermal contact area and the higher quality of the welded joint in the inventive absorber.

The inventive absorber can, in particular, have a meandering thermal fluid tube which is connected over its entire length to the absorber sheet by means of the interrupted weld seam.

Such an absorber can, in particular, be produced in a single welding operation without removal of the welding set. This leads, on the one hand, to a time saving and, on the other hand, to optimized modes of procedure during welding, since the welding set need not be removed and reapplied. This renders possible a reduction of costs of production, as well as production with a high throughput. Again, disadvantageous properties of the weld seam that can arise upon applying and removing the welding set can be avoided.

In one development of this refinement, the absorber is designed as an absorber strip. One absorber strip comprises an absorber sheet of a certain width with a thermal fluid tube fastened thereon, and can be produced in principle with any desired length. Since there is no need to apply and remove the welding set in the case of the inventive absorber, such an absorber strip can be produced in a continuous process, and this, enables a particularly high production throughput. However, the absorber can also be designed in the form of a whole area absorber, that is to say an absorber surface with specific dimensions.

In the inventive absorber, on the rear side, facing the thermal fluid tube, of the absorber sheet in the region of the contact line of the thermal fluid tube with the absorber sheet, the weld seam can be arranged in the angle between the thermal fluid tube and the absorber sheet. Such a weld seam is also called a fillet weld. In this refinement, the welded joint produces, in particular, a large contact surface between the absorber sheet and the thermal fluid tube, and this is advantageous, in particular, with regard to the transfer of heat between sheet and tube, and thus with regard to the efficiency of the absorber. A particularly large contact surface can be attained when one weld seam each is arranged on either side of the contact line. Such a weld seam is also appropriately called a double fillet weld.

In the inventive absorber, the thermal fluid tube and/or the absorber sheet can, in particular, be produced from one of the following materials, or comprise one of the following materials: copper, aluminum, steel or stainless steel.

In the inventive method for producing an absorber for a thermal solar collector, a thermal fluid tube is welded onto an absorber sheet by means of a weld seam produced with a laser beam. The laser beam is continuously present, and the path of the laser beam to the thermal fluid tube to be welded is cleared and interrupted in a temporarily changing fashion.

Using the inventive method, a thermal fluid tube can be welded onto a coated absorber sheet with an interruptedly welded weld seam produced by laser welding, for example a fillet weld or double fillet weld, without destroying the selective coating. It is particularly possible here to apply a diode laser using the CW (Continuous Wave) method. By arbitrarily deflecting/masking the laser beam permanently provided from the laser source between beam production and workpiece, it is possible to select the distances and the configuration of the weld seam as desired. Disk diode lasers are particularly suitable for the inventive method, but it is also fundamentally possible to use rod diode lasers. It will also be conceivable to use fiber lasers.

In comparison to the YAG (YAG: yttrium aluminum garnet) lasers used for welding in methods according to the prior art, as against a lamp-pumped laser source a diode laser has the significant advantage of a smaller fiber diameter which, in turn, permits a finer focusing of the energy beam, and thus a positioning of the energy beam with point accuracy.

The use of a CW diode laser enables a continuous and uniform provision of the energy required for the manufacturing process without the need to take account of the charge cycles of a pulsed laser source (charging and discharging) and the associated formation of amplitude in the manufacturing process. Focusing can be performed even more finely.

Of particular importance is the smaller fiber diameter when the energy beam is injected into and coupled out from the material (ramping up and ramping down) which, in the case of conventional laser welding methods, can easily lead to perforation of the sheet and/or to the destruction of the selective coating, or leads to removal of material at the welding points.

Manufacturing methods with a pulsed laser source chiefly make use of coated aluminum sheets with a thickness of 0.4 mm. Such laser welding methods generally require low manufacturing tolerances which, however, lead to a very different formation of the individual spot welds in terms of shape and quality. These methods are characterized by the material which is thrown up by the high and abrupt discharge of energy and is partially removed, and which then serves the purpose of connection. Here, an elongated deep crater results in the material per spot weld.

This formation of craters in the sheet leads to a perforation of the sheet along the connecting line. A consideration of the tensile strength (10⁻⁷ in N/m²) in the use of various materials such as copper (40) and aluminum (25) makes plain that it is possible to avoid an aluminum sheet in use from being weakened in the manufacturing process. Given action on the material of dynamic forces caused by thermal load changes, this leads in the long term to cracks in the sheet and to power losses, as studies show.

A whole area corrosion protection applied to the rear side (nonselective side) of the sheet is, moreover, damaged at the material accumulations. Long term studies have shown that this feature leads to oxidation of the respective spot weld, and thus to an additional weakening of the structure. Removal of a spot weld gives rise to a higher loading of the neighboring spot welds which are likewise removed under permanent loading because of the absorption of the forces additionally resulting therefrom (zipper effect).

A thereby lower and uniform input of energy such as is to be implemented with the inventive method forms weld zones only slightly and in very small points. This state of affairs in conjunction with a fine focusing renders possible a welded fillet weld or double fillet weld which is to be interrupted arbitrarily, without destruction of the material, lying virtually at the top dead point, that is to say the contact point of the thermal fluid tube with the absorber sheet. Particular importance is owed here to the fact that it is only thereby that the laser beam can be guided exactly and continuously at an appropriate irradiation angle over the entire tube length in the dead space between tube and sheet. Consequently, in a development of the inventive method the energy of the laser beam is input during welding at an angle formed between absorber sheet and thermal fluid tube.

With the energy beam being introduced at an appropriate angle to one another, the thereby short distance between tube and sheet leads to simultaneous fusing of the two materials which are therefore interconnected and lead to a connection which is material and frictional. The extremely short distance between tube and sheet ensures a small input of energy, and thus rapid cooling of the weld zone without there being a tendency to perforation of the sheet, or to destruction of the coating. Owing to the forward movement in the welding process, a mixing of the materials takes place in the weld zone, and this leads to a compensating action of the microstructure in conjunction with mechanical and thermal loading.

Given the embodiment of a double fillet weld, the inventive method can additionally be used to configure the two weld seams differently and independently from one another in one step. This possibility comes to bear, in particular, in the bends of the meanders that are mostly used, but in particular in the case of designs exceeding standard dimensions.

Owing to the temporary clearance and interruption of the continuously provided laser beam (CW laser), which can, for example, be implemented by temporarily deflecting or masking the laser beam, an abrupt high introduction of energy into the material is avoided, and a welded joint with arbitrary interruptions of the fillet weld seam is possible, without hotspots (sporadic overheating of the material) or removal of material having to be accepted. By way of example at least one movable mirror, for example a galvanometer mirror, can be applied for the purpose of temporarily clearing and interrupting the laser beam. Such a mirror has short reaction times and therefore enables the laser beam to be deflected at a high deflecting frequency. An alternative possibilities for clearing and interrupting the laser beam is offered by a movable interrupter element that temporarily interrupts the path of the laser at specific the positions Examples of movable interrupter elements are rotating pinhole diaphragms, rotating vanes, oscillating diaphragms, etc. As a further alternative, use can be made of a switchable element which changes its transmission behavior upon application of a voltage.

The processing speed to be attained with the aid of the inventive method amounts to a multiple by comparison with pulsed laser welding methods which are used in manufacturing absorbers and are in accord with the prior art. In this case, the process reliability of the manufacturing method increases in conjunction with a clear increase in batch sizes.

The absorption of forces caused by thermal load variation during application of the end product is already ensured with a simple weld seam by the frictional welded joint thereby produced, without the occurrence of a zipper effect. Here, mixing the two materials together has a compensating effect.

The welding points are located near the top dead point, and are therefore scarcely visible. They are solid, flat and elongated.

It is possible to exert a configuring influence on geometric and thermal requirements of the entire structure with the freely flexible and variably selectable weld seam or weld seams as regards shape and length.

In addition, by contrast with welding using a pulsed YAG laser, heat input into the absorber surface during welding with a diode laser using the CW method is reduced. The reduction in the heat input particularly enables even bent tube sections to be welded to the absorber sheet using a temporarily interrupted and cleared continuous wave operation, without destroying the selective surface. Consequently, the inventive method particularly enables the production of an inventive absorber.

By contrast, welding methods according to the prior art would bring about an excessively high input of heat into the absorber sheet in the bent section, and so would burn a hole into the sheet instead of bringing about a connection between the thermal fluid tube and the sheet. It is necessary for this reason not to connect the curved lengths.

Consequently, it has been proposed for the purpose of reducing the input of heat into the sheet to fasten the thermal fluid tube on the absorber sheet by means of a pulsed welding method instead of a continuous wave welding method.

However, a pulsed welding method does not produce a continuous weld seam, but merely spot welds spaced apart from one another, which resemble stitching. Consequently, the thermally conducting contact between the absorber sheet and the thermal fluid tube is less for a tube that is welded on in a pulsed fashion than for a tube welded on in a continuous fashion. The losses in heat transfer from the absorber sheet to the thermal fluid tube are exacerbated in view of the thermal conductivity (in W/m·K) when use is made of different materials such as, for example, copper (384), which is a very good thermal conductor, and aluminum (220), which is a greatly poorer conductor.

It is, in particular, possible to configure the method as an endless method, since the inventive welding method can be used to weld both straight and bent tube sections onto an absorber sheet using a temporarily interrupted and cleared continuous wave, and there is thus no need to remove the laser during welding. Such a method is particularly efficient.

In one refinement of the inventive method, during welding the energy of the CW diode laser is input at the angle which is formed between the absorber sheet and the thermal fluid tube in the region of the contact line. The weld seam produced using this method then fills out the angle between the thermal fluid tube and the absorber sheet and leads to a particularly large contact area between the thermal fluid tube and absorber sheet.

The welding points are solid, flat and elongated; they are located near the upper dead point of the tube and are therefore scarcely visible. The weld seam is produced by a temporarily deflected continuous wave.

The inventive welding method is particularly suitable for producing material connections between a thermal fluid tube and an absorber sheet which are produced in each case from at least one of the following materials: copper, aluminum, steel or stainless steel.

In a particular refinement of the inventive method, the thermal fluid tube and/or the absorption sheet are under mechanical stress during welding. A particularly good welding result, and a particularly good durability of the product produced can be attained by means of a suitable mechanical stressing.

An optimization of the welding operation can take place by setting the energy input of the laser beam by suitable temporary clearance and interruption of the path of the laser beam. The welding operation can furthermore be optimized as follows: by selecting a suitable optical system and/or setting a suitable incidence angle and/or by setting a suitable focusing of the laser beam and/or by setting a suitable performance characteristic of the diode laser. The more the parameters are part of the optimization process, the better is the attainable optimization. Parameters are to be determined empirically as a function of the material to be welded and the geometry of the components.

Further features, properties and advantages of the present invention emerge from the following description of exemplary embodiments with reference to the attached figures.

### BRIEF DESCRIPTION OF THE DRAWINGS

FIG. 1 shows the absorption sheet and the thermal fluid tube of a thermal solar collector in a schematic with meander.

FIG. 2 shows the absorption sheet and the thermal fluid tube of a thermal solar collector in a schematic with tube coil.

FIG. 3 shows an exemplary embodiment of the continuous welded joint between the thermal fluid tube and the absorption sheet.

FIG. 4 shows a section from an absorption sheet with a straight section of the thermal fluid tube welded thereon, in a perspective illustration.

FIG. 5 shows a section from an absorption sheet with a bent section of the thermal fluid tube welded thereon, in a perspective illustration.

FIG. 6 shows an example of the welding of the thermal fluid tube onto the absorber sheet.

FIG. 7 shows a further example of the welding of the thermal fluid tube onto the absorber sheet.

### DETAILED DESCRIPTION OF THE PREFERRED EMBODIMENT

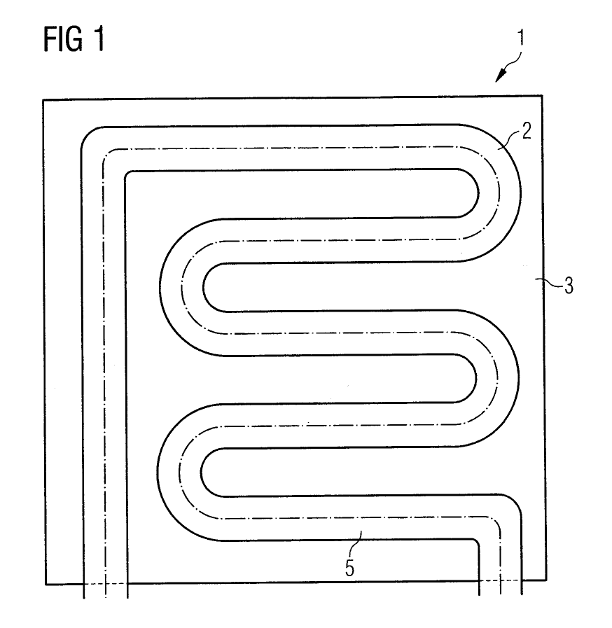

An inventive absorber is shown in FIG. 1 in a greatly simplified illustration.

The absorber 1 comprises as essential components an absorber sheet 3 with a meandering thermal fluid tube 5 welded thereon.

On its surface averted from the thermal fluid tube 5, the absorber sheet 3 has a highly selective coating that absorbs the radiant energy of the sun and converts it into heat. The heat is finally output to a thermal fluid, for example water or a water/glycol mixture, that flows through the thermal fluid tube 5 and transports the heat to its destination.

The absorber sheet 3 and the thermal fluid tube 5 welded thereon are generally arranged in a protective housing that, at least in the region of the absorbing surface of the absorber sheet 3, is configured to be transparent in such a way that it allows the insolation to pass largely unhindered. The housing itself is not illustrated in FIG. 1, for the sake of clarity.

By way of example, copper sheet with copper tube, aluminum sheet with copper tube, aluminum sheet with stainless steel tube, etc are conceivable as material combinations for the absorber sheet and the thermal fluid tube. The materials should have a high thermal conductivity in this case. Typical sheet thicknesses are in the region of between 0.1 and 0.6 mm, and typical tube diameters lie between 5 and 15 mm.

The absorber 1 illustrated schematically in FIG. 1 is a so-called whole area absorber with a meander in the case of which the thermal fluid tube 5 has a number of bent sections 2 and is, for example, applied in medium to large numbers of items in the case of standardization. In addition, it can be designed with or without a manifold for the thermal fluid. The tube ends can have screw fittings or widenings in order to simplify connection to other tubes.

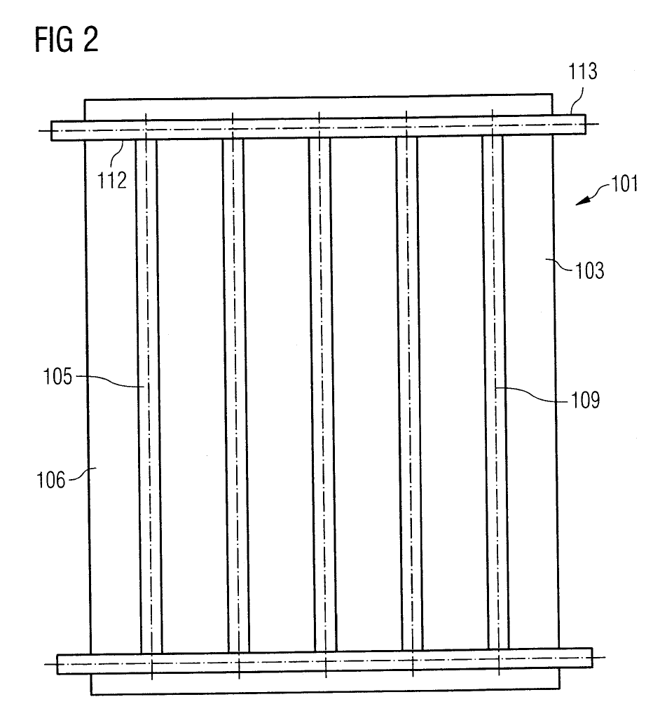

FIG. 2 is a schematic of an alternative whole area absorber 101. Instead of a meandering thermal fluid tube, the absorber 101 comprises a tube coil 112 in the case of which a plurality of thermal fluid tubes 105 are respectively connected at both their ends to a manifold 113. It is applied in medium to large numbers of items both in the case of standardization. The tube ends of the manifold 113 can have screw fittings or widenings in order to simplify connection to other tubes.

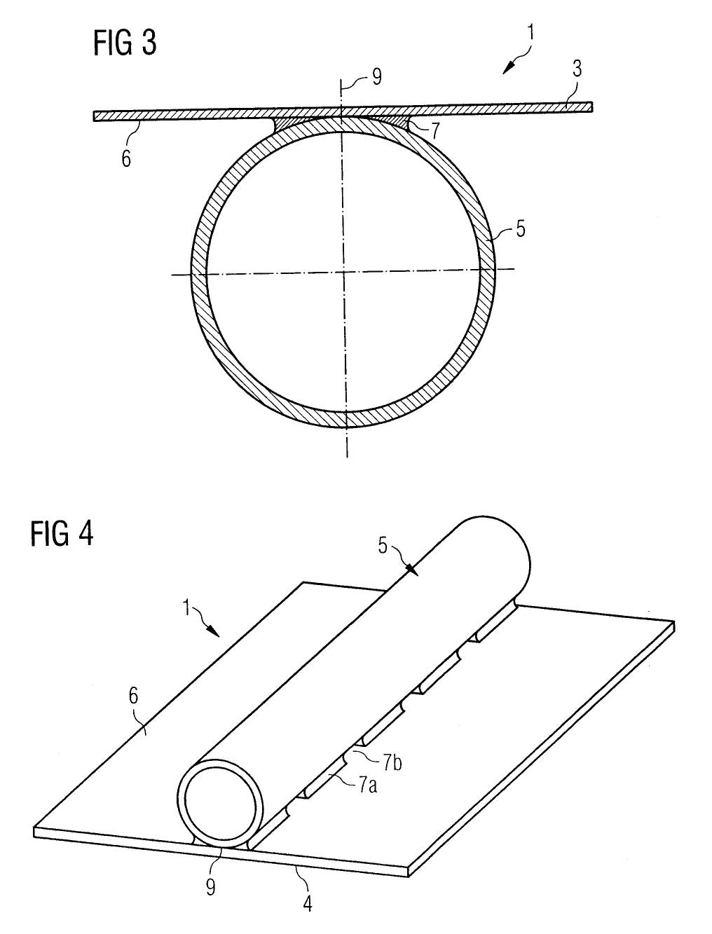

FIG. 3 shows a vertical section, running transverse to the tube longitudinal axis, through the absorber 1. The absorber sheet 3 and the thermal fluid tube 5 are to be seen. Also to be seen are the weld seams 7 via which the thermal fluid tube 5 is connected to the absorber sheet 3 by a material bond. These are formed as fillet welds arranged in the angle between the thermal fluid tube 5 and the absorber sheet 3 on the side of the contact line 9 of the thermal fluid tube with the absorber sheet 3. When, as in the present exemplary embodiment, fillet welds are present in both angles, a double fillet weld is also spoken of. In this configuration of the absorber 1, the weld seams 7 produce a joint between the absorber sheet 3 and the thermal fluid tube 5 which is thermally conducting over a relatively large area, and this enables an effective heat transfer to the thermal fluid tube 5.

FIG. 4 illustrates by way of example a detail of an absorber 1 with a straight tube section of the thermal fluid tube 5 and a weld seam 7, which is gathered out from the rear side 3 of the selectively coated side 4 and formed as a double fillet weld. The weld seam 7 has weld seam sections 7a which exhibit a linear extent along the axial direction of the thermal fluid tube 5. Located in each case between two sequentially arranged extended weld seam sections 7a is a section 7b without a weld seam which in the present exemplary embodiment exhibits a smaller linear extent than the weld seam sections 7a. The ratio of the length of the weld seam sections 7a to the sections 7b without weld seam can, however, also be different to that which is illustrated in FIG. 4, for example the two lengths can also be equal. For the weld seam in the alternative whole area absorber 101, this holds correspondingly for the weld seam 7 in the whole area absorber 1 from FIG. 1.

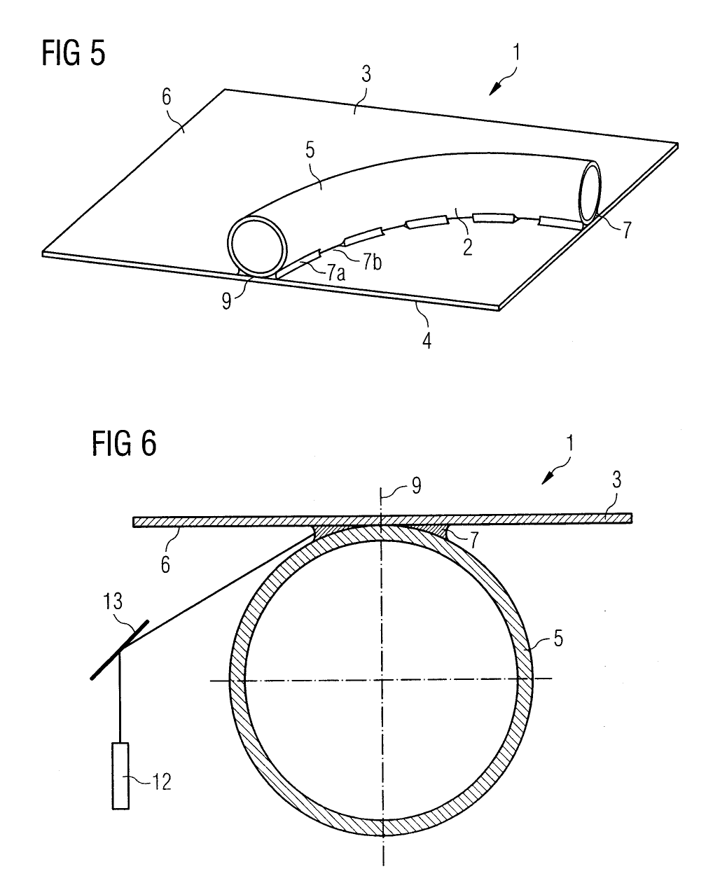

FIG. 5 illustrates by way of example a detail of an absorber 1 with a bent tube section 2 and a weld seam 7, which is gathered out from the rear side 3 of the selectively coated side 4. The weld seam 7 also has weld seam sections 7a in the bent section of the thermal fluid tube 5, which sections exhibit a linear extent along the axial direction of the thermal fluid tube 5. Located in each case between two sequentially arranged extended weld seam sections 7a is a section 7b without a weld seam which in the present exemplary embodiment exhibits a smaller linear extent than the weld seam sections 7a. The ratio of the length of the weld seam sections 7a to the sections 7b without weld seam can, however, also be different to that which is illustrated in FIG. 4, for example the two lengths can also be equal. In particular, the ratio of the length of the weld seam sections 7a to the length of the sections 7b without weld seam can differ on the two sides of the thermal fluid tube 5 in order to compensate or avoid stresses owing to the bending.

The inventive method for producing an absorber 1 is illustrated in FIG. 6. The welding of the thermal fluid tube 5 to the absorber sheet 3 is performed from the tube side 6 of the sheet 3, a diode laser 12 being applied.

The weld seam is produced in the region of the contact line 9 along which the absorber sheet 3 is in contact with the thermal fluid tube 5, specifically in the angle between the absorber sheet 3 and the thermal fluid tube 5, as is illustrated in FIG. 3. If the aim is to produce a weld seam 7 on both sides of the contact line 9, this can be achieved by virtue of the fact that, firstly, the weld seam is produced on one side and, subsequently, the weld seam is produced on the other side. However, it is also possible alternatively to produce both weld seams simultaneously when using two diode lasers 12.

However, it is also possible in principle to produce only one weld seam, that is to say merely one weld seam on one side of the contact line 9. However, because of the one-sided loading that occurs in this case it is preferred to produce two weld seams rather than produce one weld seam.

Both a rod diode laser and a disk diode laser can be used as diode laser 12. In comparison to the use of a YAG laser, it is possible, in particular, to implement reduced weld seam widths, and thus better focusing, when use is made of a disk diode laser. It is possible thereby to weld as close as possible to the contact line 9. The uniform input of energy permits two materials to be fused simultaneously at this point. A welded joint is possible without destruction of the coating owing to the resultant low energy requirement.

The weld seam 7 is produced by means of a continuously emitting laser 12. An interruption of the continuously provided radiation of energy is performed at any desired regular and freely definable intervals by temporarily deflecting or interrupting the energy beam in the feed between radiation source and optics (energy beam exit) by means of an appropriate deflecting and/or interrupting device 13. The intervals can also take place asymmetrically or acyclically on the two sides, if appropriate even in one work operation. The deflecting and/or interrupting device 13 serves the purpose of temporarily interrupting the path of the laser beam to the thermal fluid tube 5 to be welded, and is designed as a rotatable galvanometer mirror in the present exemplary embodiment.

In the exemplary embodiment described, the laser beam is deflected by a galvanometer mirror. However, it is also possible in principle to apply other movable mirrors, for example a tilting mirror or a displaceable mirror arranged on a carriage, in order to deflect the laser beam.

A further possibility consists in principle in the temporary interruption of the laser beam by a diaphragm which interrupts the laser beam at any desired point in the extent of the laser beam path (directly in or at the source, in the light guidance or at the optics). This method has by far higher reaction speeds by comparison with galvanometer mirrors used.

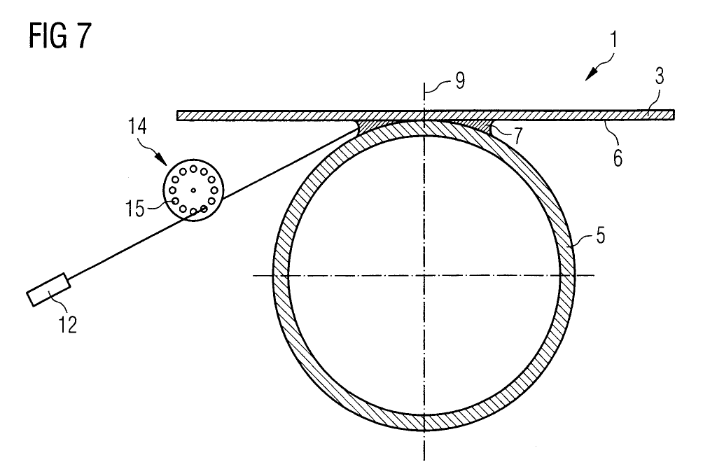

A variant thereof is illustrated in FIG. 7. A circular disk 14 is provided with a plurality of holes 15. The holes are all located on the same radius, the center point of the holes lying respectively on a smaller radius than that of the overall disk. The holes in the disk respectively have the same spaces from one another. The laser beam is aligned such that it can pass the respective holes in the disk. It is optimum here to align the laser beam in the center point of the respective hole.

The laser beam is temporarily interrupted by rotating the perforated disk 14. The material of the disk between the holes leads to interruption of the laser beam. The rotating movement of the disk is performed by a motor. By changing the speed of the motor or of the rotating disk, it is possible to vary the interruptions of the laser beam at will. The disk must contain at least one hole in order for this effect to be obtained.

Instead of a rotating perforated disk, it is also possible to conceive of a rotating vane, a rotating propeller or an oscillating diaphragm for the interruption of the laser beam.

Also conceivable as diaphragm is a glass element which prevents or varies the light flux under the influence of electric voltage. The optical properties of electrochromic layers can be varied by the absorption or output of charge carriers. When current flows, an exchange of charge carriers (for example lithium ions) takes place, and the layer changes its permeability to the incident light. Metal oxides such as, for example, tungsten oxide exhibit such color change.

In the case of switchable mirrors based on metal hydrides, transparency is increased with the aid of hydrogen gas. Electrical voltage clears up the layers of a light diffusing glazing system which are produced on the basis of liquid crystals or polarized particles (polymer dispersed liquid crystal or suspended particle devices).

Photoelectrochromic glazing, electrochromic glazing systems and their further developments can be applied in principle.

The inventive method enables thermal fluid tubes 5 to be welded onto the absorption sheet 3 not only in straight tube lengths, using temporarily deflected continuous wave operation, but also in bent tube lengths. Consequently, the inventive method can be used, in particular, to weld meandering thermal fluid tubes 5 to an absorber sheet 3 without removing the laser using the continuous wave method with temporary deflection.

The production time can be shortened, since in comparison to methods according to the prior art, in which bent tube lengths are not welded onto the absorber sheet in continuous wave laser welding, the entire tube can be welded onto the absorber sheet in one pass, that is to say without removing the laser and moving it to another site. There is no need to form the amplitude of the radiation source, something which leads to longer process times and to fixed spaces between connections. This reduces the costs and enables industrial production in distinctly larger batch sizes. Welding rates of up to 50 m/min can be attained with the aid of the inventive method. In addition, design flexibility and degrees of freedom in configuration are rendered possible for the first time by the method for the purpose of counteracting individual problems with regard to material properties, geometry and material strengths. The service life, quality and efficiency of the absorber are increased.

By suitably setting the parameterization of the optics system and/or the incidence angle and/or the focusing of the laser beam and/or the performance characteristic of the laser and/or the material feed during welding, it is possible to ensure when use is made of a diode laser that continuous wave welding with temporary deflection can be performed with material and frictional connection even in the region of bent tube lengths without introducing holes or the like into the material and into the weld seam or destroying the coating. This enhances the durability of the absorber even after many thermal load changes, and this lengthens its service life even under extreme operations.

Furthermore, when the inventive method is applied there is an increase in the process reliability of the production in conjunction with a high throughput, and the reject rate can thus be reduced.

The thermal fluid tube 5, in particular, but also the absorber sheet 3, can be put under mechanical stress during welding. The mechanical stress can help to simplify the welding operation and to attain a weld seam of relatively high quality.

Given all the advantages of the method, there is a further one of keeping the coated surface 4 of the absorber sheet 3 completely free from weld seams, this being advantageous with regard to the optimization of the area useful for absorbing the insolation, and to the resistance of the coating to environmental influences, and corresponds to the requirements of the market.

In the inventive method, ramping up can be performed before the continuous wave welding. The ramping up can prevent bringing about an excessively high energy potential of the laser beam when the diode laser is being moved up and moved away, which potential would be seen in that the material is thrown up on the surface in the region of the beginning and the end of the weld seam and the coating is damaged and holes are possibly produced or the material is weakened.

In the method described, it is also possible during welding to feed weld material into the region in which the welded joint is to be produced.

The method described also proves to be advantageous in producing absorber fins, that is to say absorbers or absorber elements that comprise a long narrow absorber sheet strip with a thermal fluid tube welded thereon, because of the only extremely slight stressing of the materials and the absorber surface and the possible high welding speeds. The inventive method is used to weld a straight tube mostly virtually in the middle over its entire length on the long narrow absorber sheet. However, instead of the straight tube it is also possible in principle to weld on a meandering tube.

The absorber fin can be assembled together with at least one further absorber fin to form a so-called strip or fin absorber in which at least two absorber fins are arranged next to one another. The thermal fluid tubes of the absorber fins then open respectively at both ends into a common distributor tube or manifold from which thermal fluid is distributed into the individual thermal fluid tubes or is collected from the individual thermal fluid tubes.

Instead of the absorber fin being used to build up a strip or fin absorber, it can also be employed to build up a vacuum absorber. To this end, the absorber fin is introduced into a glass tube that is subsequently sealed in a gastight fashion at both ends and evacuated. After being introduced into the glass tube, the ends of the thermal fluid tube project from the welded ends and are soldered into a distributor tube or manifold that is, for example, drilled. Given appropriate dimensions of the tube in relation to the dimension of the absorber fins, two or more absorber fins can possibly be introduced next to one another into the tube.

1. Absorber (1) for a thermal solar collector, comprising an absorber sheet (3) and at least one thermal fluid tube (5) that is connected in a thermally conducting fashion to the absorber sheet (3) and is connected to the absorber sheet (3) by means of a welded joint, characterized in that the welded joint is formed from a number of linearly extended weld seam sections arranged sequentially along the thermal fluid tube (5) and respectively separated from one another by a section without weld seam, the direction of the linear extent of the weld seam sections corresponding to the axial direction of the extent of the thermal fluid tube.

2. Absorber (1) according to claim 1, characterized in that present as thermal fluid tube (5) is a meandering thermal fluid tube which is connected over its entire length to the absorber sheet (3) by means of the welded joint (7).

3. Absorber (1) according to claim 2, characterized by its configuration as a whole area absorber or absorber strip.

4. Absorber (1) according to claim 2, characterized in that on the rear side (6), facing the thermal fluid tube (5), of the absorber sheet (3) the weld seam (7) is arranged in the angle between the thermal fluid tube (5) and the absorber sheet (3).

5. Absorber (1) according to claim 4, characterized in that one weld seam (7) each, having sequentially arranged weld seam sections respectively separated from one another by a section without weld seam, is arranged on each side of the thermal fluid tube (5).

6. Absorber (1) according to claim 1, characterized in that at least one of the thermal fluid tube (5) and the absorber sheet (3) is comprises at least one of copper, aluminum, steel or stainless steel.

7. Method for producing an absorber (1) for a thermal solar collector for producing an absorber according to claim 1, in which a thermal fluid tube (5) is welded onto an absorber sheet (3) by means of a weld seam produced with a laser beam, characterized in that the laser beam is continuously present and the path of the laser beam to the thermal fluid tube to be welded is cleared and interrupted in a temporarily changing fashion.

8. Method according to claim 7, characterized in that the temporary changing between clearance and interruption of the path of the laser beam is performed by temporarily deflecting the laser beam.

9. Method according to claim 8, characterized in that at least one movably arranged mirror is applied for the purpose of temporarily deflecting the laser beam.

10. Method according to claim 7, characterized in that a rotating or oscillating interrupter element is used in order to bring about the temporary change between clearance and interruption of the path of the laser beam, with the path of the laser being temporarily interrupted at specific the rotating positions or pivoting positions of the interrupter element.

11. Method according to claim 7, characterized in that a switchable element which change its transmission behavior upon application of a voltage is applied in order to bring about the temporary change between clearance and interruption of the path of the laser beam.

12. Method claim 9, characterized in that a diode laser is applied as laser.

13. Method according to claim 7, characterized in that the welding is carried out using an endless method.

14. Method according to claim 1, characterized in that during welding the energy of the laser beam (12) is input into an angle formed between the absorber sheet (3) and the thermal fluid tube (5).

15. Method according to claim 1, characterized in that the welding method produces a material connection between a thermal fluid tube (5) and an absorption sheet (3), which respectively consist of at least one of the following materials, or respectively comprise at least one of the following materials: copper, aluminum, steel or stainless steel.

16. Method according to claim 1, characterized in that the energy input of the laser beam is optimized by suitable temporary clearance and interruption of the path of the laser beam.

17. Method according to claim 7, characterized in that at least one of the thermal fluid tube (5) and the absorber sheet (3) is under mechanical stress during welding.
